(19) United States
(12) Patent Application Publication
(10) Pub. No.: US 2018/0181384 A1
(43) Pub. Date: Jun. 28, 2018

(54) METHOD AND STORAGE SYSTEM FOR UPDATING SOFTWARE IN A STORAGE SYSTEM

(71) Applicant: Wistron Corp., New Taipei City (TW)

(72) Inventors: Shih-Hui Chang, New Taipei City (TW); Ming-Sheng Wu, New Taipei City (TW)

(21) Appl. No.: 15/469,418

(22) Filed: Mar. 24, 2017

(30) Foreign Application Priority Data
Dec. 27, 2016 (TW) 105143318

(51) Int. Cl. G06F 9/445; G06F 3/06

(52) U.S. Cl. CPC G06F 8/65; G06F 3/0685; G06F 3/0619; G06F 3/0635; G06F 3/0659

(57) ABSTRACT

A method for updating software in a storage system is provided. The method is used in the storage system and includes: providing a new region in a random access memory (RAM); downloading second software to the new region and running the second software; determining whether data path settings have been initialized; and setting the new region as an active region and setting a current active region in the RAM as the new region when determining that the data path settings are initialized.

### CROSS REFERENCE TO RELATED APPLICATIONS

This application claims priority of Taiwan Patent Application No. 105143318, filed on Dec. 27, 2016, the disclosure of which is incorporated herein by reference in its entirety.

### BACKGROUND OF THE INVENTION

### Field of the Invention

The present invention relates to a storage system. More specifically, the present invention relates to a method and a storage system for updating software in the storage system.

### Description of the Related Art

A commercially available storage system (such as a Just-a-Bunch-of-Flash (JBOF) system) has to stop its system and wait for an update of system software to complete when updating the system software. In addition, the storage system further needs to be rebooted to be able to continue running.

However, a general data center provides round-the-clock service. To update the system software for the storage system, the data center needs to temporarily stop service. The situation described above may result in inconvenience to users and increase the operating costs of the data center. If information handled by the data center is related to banks, it will cost more to ensure that the storage system is functioning properly.

In view of the foregoing, there is a need for a method and a storage system for updating system software in the storage system to ensure that the storage system can continue running without rebooting when updating the system software.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

A method and a storage system for updating software in the storage system are provided.

In a preferred embodiment, a method for updating software in a storage system is provided in the invention. The method is used in the storage system and includes: providing a new region in a random access memory (RAM); downloading second software to the new region and running the second software; determining whether data path settings have been initialized; and setting the new region as an active region and setting a current active region in the RAM as the new region when determining that the data path settings are initialized.

In some embodiments, after setting the new region as the active region and setting the current active region as the new region, the method further comprises: initializing control path settings; and writing the second software into a flash memory. In some embodiments, when determining that the data path settings have not been initialized, the method further comprises: initializing the data path settings. In some embodiments, the current active region comprises first software which the storage system is running. In some embodiments, the storage system provides at least a data path and at least a control path. In some embodiments, the storage system is a Just-a-Bunch-of-Flash (JBOF) system.

In a preferred embodiment, a storage system is provided in the invention. The storage system comprises a control circuit, a processor and a memory. The processor is installed in the control circuit. The memory is installed in the control circuit and is operatively coupled to the processor. The processor is configured to execute a program code stored in the memory to perform operations comprising: providing a new region in a random access memory (RAM); downloading second software to the new region and running the second software; determining whether data path settings have been initialized; and setting the new region as an active region and setting a current active region in the RAM as the new region when determining that the data path settings are initialized.

In some embodiments, after setting the new region as the active region and setting the current active region as the new region, the processor further executes the program code to perform operations comprising: initializing control path settings; and writing the second software into a flash memory. In some embodiments, when determining that the data path settings have not been initialized, the processor further executes the program code to perform operations comprising: initializing the data path settings. In some embodiments, the current active region comprises first software which the storage system is running. In some embodiments, the storage system provides at least a data path and at least a control path. In some embodiments, the storage system is a Just-a-Bunch-of-Flash (JBOF) system.

### BRIEF DESCRIPTION OF DRAWINGS

The accompanying drawings are included to provide a better understanding of the invention, and are incorporated in and constitute a part of the present invention. The drawings illustrate implementations of the invention and, together with the description, serve to explain the principles of the invention. It should be appreciated that the drawings are not necessarily to scale as some components may be shown out of proportion to the size in actual implementation in order to clearly illustrate the concept of the present invention.

FIG. 1 is an exemplary schematic diagram illustrating a storage architecture 100 in accordance with one embodiment of the invention.

FIG. 2 is a simplified functional block diagram of a memory according to one embodiment of the present invention.

FIG. 3 is a flow diagram illustrating a method for updating software in a storage system according to an embodiment of the present invention.

### DETAILED DESCRIPTION OF THE INVENTION

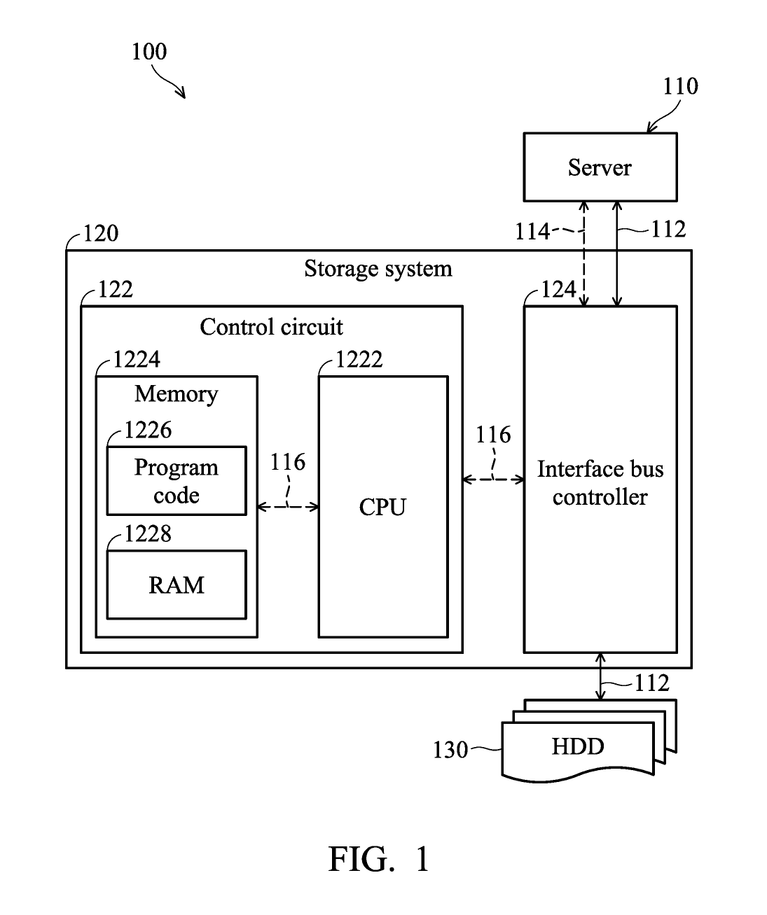

Several exemplary embodiments of the present disclosure are described with reference to FIGS. 1 through 3 which generally relate to a method and a storage system for updating software in the storage system. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The term “exemplary” means that the disclosed element or embodiment is only an example, and does not indicate any preference of the user. Furthermore, like numerals refer to like elements throughout the several views, and the articles “a” and “the” include plural references, unless otherwise specified in the description.

FIG. 1 is an exemplary schematic diagram illustrating a storage architecture 100 in accordance with one embodiment of the invention. A server 110 may store data into and retrieve data from a memory of a storage system 120. In other embodiments, the server 110 may store data into and retrieve data from a hard disk drive (HDD) 130. The storage system 120 may be a Just-a-Bunch-of-Flash (JBOF) system, which can be embedded within a host, such as in the form of a solid state disk (SSD) drive installed in a personal computer.

In FIG. 1, the storage system 120 can comprise an interface bus controller 124, a control circuit 122, a central processing unit (CPU) 1222, a memory 1224, a program code 1226 and a random access memory (RAM) 1228. The interface bus controller 124 provides access to the storage system 120. The storage system 120 can be connected to the server 110 and a hard disk drive 130 via a data path 112. The data path 112 may comprise a storage area network (SAN) or a similar communications channel. The data path serves to rapidly transfer large quantities of data between the server 110 and the storage system 120.

The storage system 120 may communicate control information over a control path 114 to the server 110. The storage system 120 can also include a separate control path 116. The control paths 114 and 116 are shown as dashed lines to indicate that the storage system 120 transmits and receives control signals. The control circuit 122 executes the program code 1226 in the memory 1224 through the CPU 1222, thereby controlling the operation of the storage system 120.

In another embodiment, the storage system 120 can also provide a virtual path, which is configured to divide received signals or data into control signals (provided on the control path) and data (provided on the data path).

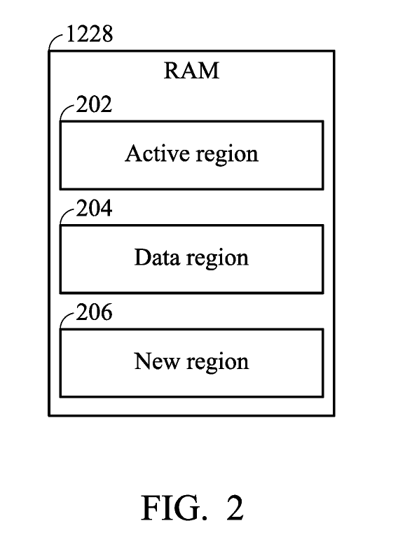

In addition, the memory 1224 may further comprise a flash memory (not shown in FIG. 1), wherein the flash memory can store software, i.e. program instructions and data. The RAM 1228 can be included in the memory 1224, which may be divided into three regions, as shown in FIG. 2. The RAM 1228 provides an active region 202, a data region 204, and a new region 206. The active region 202 includes first software which the storage system 120 is running. The new region 206 includes a new version of the software downloaded by the storage system 120. The data region 204 includes software settings and settings related to the data path.

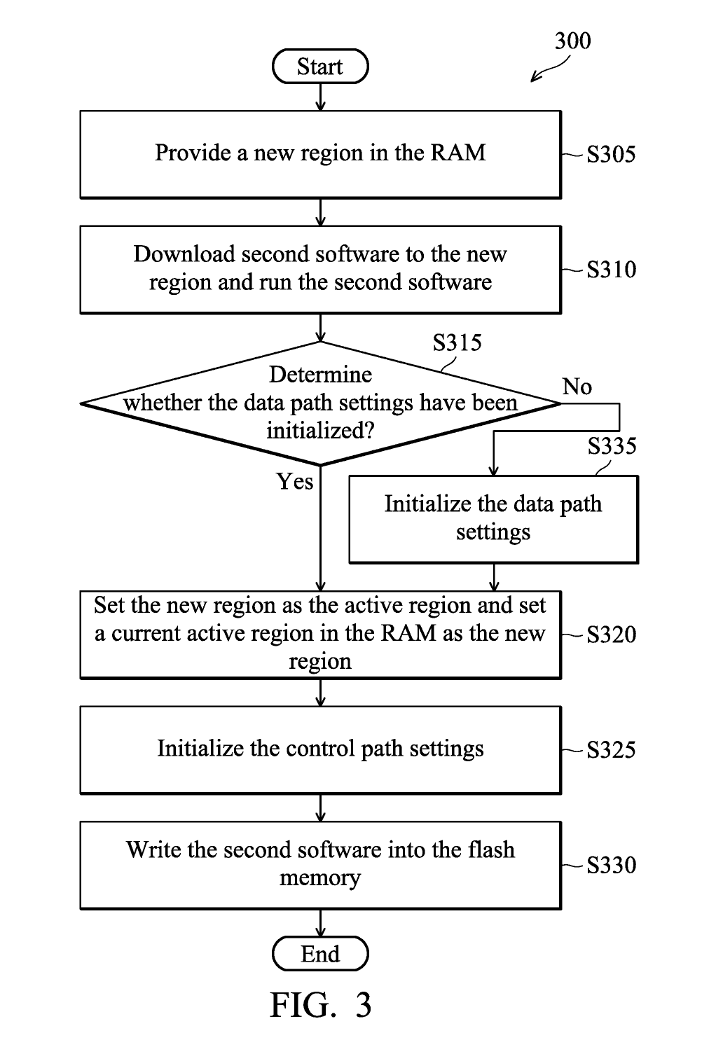

FIG. 3 is a flow diagram 300 illustrating a method for updating software in a storage system according to an embodiment of the present invention. The method is used in the storage system which is running the first software. In step S305, the storage system provides a new region in the RAM. Next, in step S310, the storage system downloads second software to the new region and runs the second software. In step S315, the storage system determines whether the data path settings have been initialized. When the storage system determines that the data path settings have been initialized (“Yes” in step S315), in step S320, the storage system sets the new region as the active region and sets a current active region in the RAM as the new region. In other words, the storage system sets the new region as the active region, and sets the original active region as the new region. Then, in step S325, the storage system initializes the control path settings. In step S330, the storage system writes the second software into the flash memory.

When the storage system determines that the data path settings have not been initialized (“No” in step S315), in step S335, the storage system initializes the data path settings. Then, the flow goes back to step S320.

In addition, the CPU 1222 may execute the program code 1226 to perform all of the above-described actions and steps or others described herein.

Therefore, since the data path settings in the data region have been initialized, the data path service can continue being implemented through the method and the storage system for updating software in the storage system disclosed in the invention so that the storage system can run the new version of the software without rebooting.

Various aspects of the invention have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in ways that vary for each particular application, but such implementation decisions should not be interpreted as causing a departure from the scope of the present invention.

In addition, the various illustrative logical blocks, modules, and circuits described in connection with the aspects disclosed herein may be implemented within or performed by an integrated circuit (“IC”), an access terminal, or an access point. The IC may comprise a general-purpose processor, a digital signal processor (DSP), an application-specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general-purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. It should be understood that the specific order or hierarchy of steps in the processes may be rearranged while remaining within the scope of the present invention. The accompanying method claims present elements of the various steps in a sample order, and are not meant to be limited to the specific order or hierarchy presented.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of exemplary embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for updating software in a storage system, used in the storage system, comprising:
providing a new region in a random access memory (RAM);
downloading second software to the new region and running the second software;
determining whether data path settings have been initialized; and
setting the new region as an active region and setting a current active region in the RAM as the new region when determining that the data path settings are initialized.

2. The method for updating software in the storage system as claimed in claim 1, wherein after setting the new region as the active region and setting the current active region as the new region, the method further comprises:
initializing control path settings; and
writing the second software into a flash memory.

3. The method for updating software in the storage system as claimed in claim 1, wherein when determining that the data path settings have not been initialized, the method further comprises:
initializing the data path settings.

4. The method for updating software in the storage system as claimed in claim 1, wherein the current active region comprises first software which the storage system is running.

5. The method for updating software in the storage system as claimed in claim 1, wherein the storage system provides at least a data path and at least a control path.

6. The method for updating software in the storage system as claimed in claim 1, wherein the storage system is a Just-a-Bunch-of-Flash (JBOF) system.

7. A storage system, comprising:
a control circuit;
a processor, installed in the control circuit; and
a memory, installed in the control circuit and operatively coupled to the processor,
wherein the processor is configured to execute a program code stored in the memory to perform operations comprising:
providing a new region in a random access memory (RAM);
downloading second software to the new region and running the second software;
determining whether data path settings have been initialized; and
setting the new region as an active region and setting a current active region in the RAM as the new region when determining that the data path settings are initialized.

8. The storage system as claimed in claim 7, wherein after setting the new region as the active region and setting the current active region as the new region, the processor further executes the program code to perform operations comprising:
initializing control path settings; and
writing the second software into a flash memory.

9. The storage system as claimed in claim 7, wherein when determining that the data path settings have not been initialized, the processor further executes the program code to perform operations comprising:
initializing the data path settings.

10. The storage system as claimed in claim 7, wherein the current active region comprises first software which the storage system is running.

11. The storage system as claimed in claim 7, wherein the storage system provides at least a data path and at least a control path.

12. The storage system as claimed in claim 7, wherein the storage system is a Just-a-Bunch-of-Flash (JBOF) system.
